(19) United States
(12) Patent Application Publication
(10) Pub. No.: US 2025/0016766 A1
(43) Pub. Date: Jan. 9, 2025

(54) METHOD AND APPRATUS FOR RELAY NODE ID ACQUISITION

(71) Applicant: MEDIATEK INC., Hsinchu City (TW)

(72) Inventors: Guan-Yu LIN, Hsinchu City (TW); Chia-Hao YU, Hsinchu City (TW); Lung-Sheng TSAI, Hsinchu City (TW); Nathan Edward TENNY, San Jose, CA (US)

(21) Appl. No.: 18/710,966

(22) PCT Filed: Jan. 10, 2023
(86) PCT No.: PCT/CN2023/071555

§ 371 Date: May 16, 2024

Related U.S. Application Data
(60) Provisional application No. 63/297,844, filed on Jan. 10, 2022.

(51) Int. Cl. H04W 72/1263; H04B 7/155; H04W 88/04

(52) U.S. Cl. CPC H04W 72/1263; H04B 7/15528; H04W 88/04

(57) ABSTRACT

A synergetic communication method for relay node identification (ID) acquisition is proposed. The network node may generate a configuration based on the relay node information from a user equipment (UE) to configure the relay node ID for the relay node in an aggregated group. The network node may schedule the operations of the devices of the aggregated group based on the configuration. The UE may detect the relay node and assign the relay node ID configured by the network node to the relay node in the aggregated group. Therefore, when the relay node in the aggregated group cannot directly obtain the relay node ID from the network node, the UE can assist of obtaining the relay node ID from the network node and assigning the relay node ID to the relay node in the aggregated group.

### CROSS REFERENCE TO RELATED APPLICATIONS

This application claims priority under 35 U.S.C. § 119 from U.S. Provisional Application No. 63/297,844, entitled “On Relay Node ID Acquisition to support Synergetic UE Communication”, filed on Jan. 10, 2022, the subject matter of which is incorporated herein by reference.

### TECHNICAL FIELD

The disclosed embodiments relate generally to wireless communication, and, more particularly, to relay node identification (ID) acquisition in mobile communications.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. The next generation mobile network (NGMN) board, has decided to focus the future NGMN activities on defining the requirements for 5G new radio (NR) systems or 60 systems.

In conventional 5G technology, the relay communication via a relay node has the potential to modernize mobile communications for vehicles or other application scenarios. However, when the network node cannot obtain a relay node identification (ID) due to the limited capability of the relay node, e.g., the relay node is a layer 0 (L0) relay node or a layer 1 (L1) relay node, the network node is not able to control the relay node.

A solution for relay node ID acquisition is sought.

### SUMMARY

A synergetic communication method for relay node identification (ID) acquisition is proposed. The network node may generate a configuration based on the relay node information from a user equipment (UE) to configure the relay node ID for the relay node in the aggregated group. In addition, the network node may schedule the operations of the devices of the aggregated group based on the configuration. The UE may detect the relay node and assign the relay node ID configured by the network node to the relay node in the aggregated group. Therefore, when the relay node in the aggregated group cannot directly obtain the relay node ID from the network node, the UE can assist of obtaining the relay node ID from the network node and assigning the relay node ID to the relay node in the aggregated group.

In one embodiment, a user equipment (UE) may detect at least one relay node. The UE may transmit a relay node information to a network node, wherein the replay node information comprises information of the at least one relay node. The UE may receive a configuration for controlling the at least one relay node from the network node. The UE may receive a scheduling from the network node, wherein the scheduling is scheduled based on the configuration. In addition, the UE may perform data transmission or data reception with the at least one relay node and the network node based on the scheduling.

In one embodiment, the UE may transmit the configuration to the at least one relay node, wherein the configuration comprises a relay node identification (ID) of the at least one relay node.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary synergetic communication network in accordance with aspects of the current invention.

FIG. 2A is a schematic diagram of an aggregated group in accordance with one novel aspect.

FIG. 2B is a schematic diagram of an aggregated group in accordance with another novel aspect.

FIG. 2C is a schematic diagram of an aggregated group in accordance with another novel aspect.

FIG. 3 is a simplified block diagram of a network node and a user equipment that carry out certain embodiments of the present invention.

FIG. 4 illustrates a synergetic communication procedure in accordance with one novel aspect.

FIG. 5 is a flow chart of a synergetic communication method for relay ID acquisition in accordance with one novel aspect.

### DETAILED DESCRIPTION

Reference will now be made in detail to some embodiments of the invention, examples of which are illustrated in the accompanying drawings.

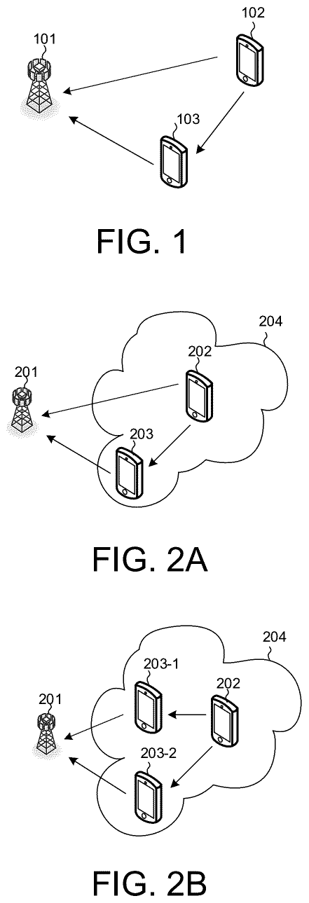

FIG. 1 illustrates an exemplary synergetic communication network 100 in accordance with aspects of the current invention. The synergetic communication network 100 comprises a network node 101, a user equipment (UE) 102 and at least one relay node 103. It should be noted that FIG. 1 only shows one relay node 103, but the invention should not be limited thereto. The synergetic communication network 100 may be applied to Sidelink (SL) communication or other application scenarios.

The network node 101 may be communicatively connected to a user equipment (UE) 102 operating in a licensed band (e.g., 30 GHz˜300 GHz for mmWave) of an access network which provides radio access using a Radio Access Technology (RAT) (e.g., the 5G NR technology). The access network may be connected to a 5G core network by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy.

The network node 101 may be a base station (BS) or a gNB.

The UE 102 may be a smart phone, a wearable device, an Internet of Things (IoT) device, and a tablet, etc. Alternatively, UE 102 may be a Notebook (NB) or Personal Computer (PC) inserted or installed with a data card which includes a modem and RF transceiver(s) to provide the functionality of wireless communication.

The relay node 103 may be a layer 2 (L2) relay node, a layer 1 (L1) relay node or a layer 0 (L0) relay node.

L2 relay node may have capability of decoding the received packets to the level of L2 packets (i.e., in the unit of Medium-Access-Control Protocol-Data-Unit (MAC PDU), MAC Service Data Unit (SDU), RLC SDU, Radio Link Control (RLC) PDU, Packet Data Convergence Protocol (PDCP) SDU, or PDCP PDU), assembling the received L2 packets to form a new MAC PDU and forwarding the new MAC PDU to the next hop. That is to say, the L2 relay node may have similar functionalities as the UE 102. In L2 relay, a L2 relay node connects to the network before it transmits discovery message to announce itself as a L2 relay UE. During network connection establishment, a L2 relay node directly obtains the relay node identification (ID) from the network node 101 (same as legacy UE). That is, L2 relay node has capability to acquire its distinct network-recognizable ID (i.e., Cell-Radio Network Temporary Identifier (C-RNTI)) from the network directly.

L1 relay node may have functionalities between L0 relay node and L2 relay node. In an example, L1 relay node does not do L2 decoding for received control signaling and data which is to be forwarded to the network or other UE but is not for itself. In another example, the L1 relay node may support L2 decoding for its own control signaling, i.e. L1 relay node may be configured by L1 (e.g., Channel State Information (CSI) and/or Downlink Control Information, DCI) or L2 signaling (MAC Control Element (CE) or Radio Resource Control (RRC) configuration). L1 relay node may perform L1 procedure such as beam management, power control, or time slot specific on-off operation, which may follow the instruction of the received control signaling from the network. L1 relay node may not directly obtain the relay node identification (ID) from the network node 101, i.e., a L1 relay node may not have a UE ID (e.g., C-RNTI for network recognition) assigned by the network.

L0 relay node may only have the capability of amplifying and forwarding the received signal. L0 relay node may not directly obtain the relay node identification (ID) from the network node 101 (e.g., C-RNTI).

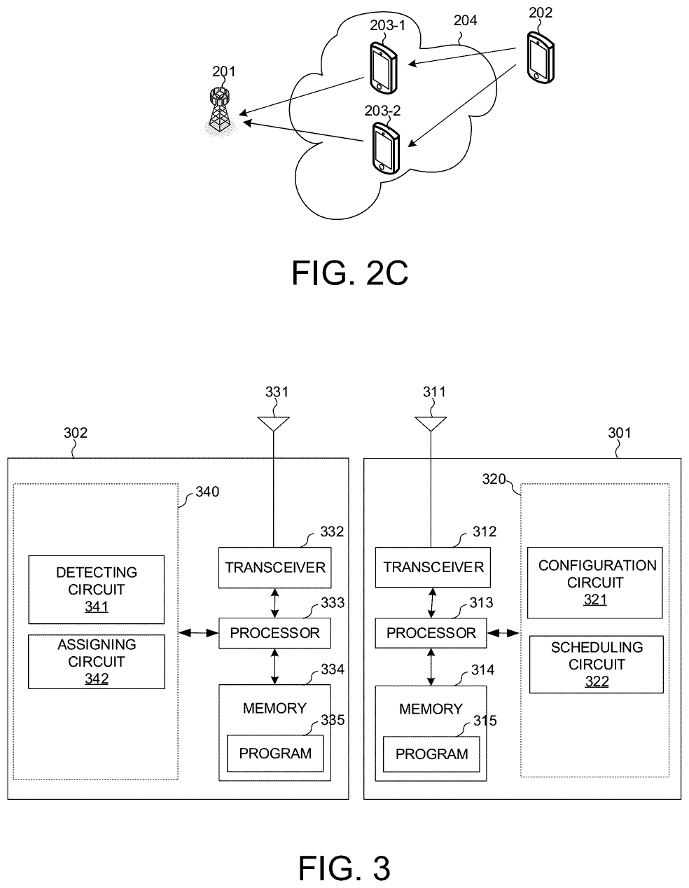

In accordance with one novel aspect, the UE 102 and the relay node(s) 103 may form an aggregated group. The UE 102 may coordinate the operations in the aggregated group. Taking FIG. 2A and FIG. 2B as examples. As shown in FIG. 2A, UE 202 and relay node 203 may form an aggregated group 204. As shown in FIG. 2B, UE 202, relay node 203-1 and relay node 203-2 may form an aggregated group 204. The type of aggregated group may be based on the type of the relay node(s) (e.g., the relay node is L2 relay node, L1 relay node or L0 relay node) in the aggregated group.

In accordance with another novel aspect, the relay nodes 103 may form an aggregated group, i.e., the aggregated group does not comprise the UE 102. In the aggregated group, a relay node 103 may be regarded as a master relay node (or relay node lead) which has better capability than other relay nodes 103 of the aggregated group, e.g., the master relay node is a L2 relay node and other relay nodes of the aggregated group are L1 relay nodes or L0 relay node. Taking FIG. 2C as an example. As shown in FIG. 2C, the aggregated group 204 may comprise the relay node 203-1 and relay node 203-2 and the relay node 203-1 is the master relay node. The master relay node may coordinate the operations in the aggregated group.

In accordance with a novel aspect, when the UE 102 detects at least one relay node 103, the UE 102 may transmit relay node information associated with the at least one relay node 103 to the network node 101. The network node 101 may determine or configure a configuration for controlling the at least one relay node 103 and transmit the configuration to the UE 102. In addition, the network node 101 may schedule a scheduling based on the configuration and transmit the scheduling to the UE 102. The UE 102 may perform data transmission or data reception with the at least one relay node 103 and with the network node 101 based on the scheduling.

In accordance with a novel aspect, the relay node information may comprise capability information of an aggregated group. When the UE 102 detects at least one relay node 103, the UE 102 may obtain the capability of each relay node 103 in the aggregated group to generate the relay node information. In an example, when the aggregated group is formed by the UE 102 and the at least one relay node 103, the capability information may comprise the capability of the UE 102 and the capability of each relay node 103. In another example, when the aggregated group is formed by the at least one relay node 103, the capability information may comprise the capability of each relay node 103. The network node 101 may determine or configure the configuration for controlling the relay node 103 based on the capability information of the aggregated group.

In accordance with a novel aspect, the relay node information may further comprise a semi-static unique ID (e.g., a sequence number used to identify the relay node) of relay node 103. When the UE 102 detects the relay node 103, the UE 102 may obtain the semi-static unique ID of relay node 103.

In accordance with a novel aspect, the configuration configured by the network node 101 may comprise a relay node identification (ID) of each relay node 103 in the aggregated group. The network node 101 may distinguish the devices in the aggregated group based on the relay node ID of each relay node 103. In an example, when the UE 102 obtains the relay node ID of each relay node 103 configured in the configuration from the network node 101, the UE 102 may assign the relay node ID to the each relay node 103 in the aggregated group. In another example, when the master relay node of the aggregated group (i.e., the aggregated group does not comprise the UE 102) obtains the relay node ID of each relay node 103 configured in the configuration from the network node 101, the master relay node may assign the relay node ID to the each relay node 103 in the aggregated group.

In accordance with a novel aspect, the relay node ID of each relay node 103 in the aggregated group may be unique in a cell or an area (e.g., tracking area, Public Land Mobile Network (PLMN) area, Radio Access Network (RAN) area, system information area, or an area consisting of several cells).

In an example, one relay node 103 may have its own relay node ID (i.e., C-RNTI), i.e., this relay node is a L2 relay node. Therefore, the network node 101 may directly assign the relay node ID to the L2 relay node without through the UE 102.

In another example, the network node 101 may assign a unique relay node ID in a cell or an area for each L1 relay node and each L0 relay node in the aggregated group. For example, a L1 relay node or a L0 relay node may have a semi-static unique ID. Therefore, when the UE 102 or a master relay node in the aggregated group transmits the relay node information with the semi-static unique ID of a L1 relay node or a L0 relay node to the network node 101, the network node 101 may assign the relay node ID to the L1 relay node or the L0 relay node, wherein the assigned relay node ID is unique in a cell, in an area, or within the aggregated group. As another example, for a L1 relay node or a L0 relay node in the aggregated group, only when the UE 102 or a master relay node in the aggregated group transmits the relay node information to the network node 101, the network node 101 may assign a unique relay node ID (e.g., a per-cell relay node ID) in a cell or an area for the L1 relay node or the L0 relay node. Then, the UE 102 or the master relay node in the aggregated group may transmit the configuration with the assigned relay node ID to the L1 relay node or the L0 relay node.

In accordance with another novel aspect, the relay node ID of each relay node 103 in the aggregated group may be unique and associated with the aggregated group.

In an example, when the aggregated group comprises the UE 102, the relay node ID of each relay node 103 in the aggregated group may be associated with the UE 102. Specifically, each relay node 103 in the aggregated group associated with the UE 102 may have a unique local relay node ID assigned by the network node 101. The network node 101 may identify and control (or schedule) the devices in the aggregated group based on a source ID of the UE 102 and the unique local relay node ID of each relay node 103. In addition, in the example, the relay node 103 may have a local relay node ID for the UE 102 and a pre-cell relay node ID.

In another example, when the aggregated group does not comprise the UE 102, the relay node ID of each relay node 103 in the aggregated group may be associated with the aggregated group ID of the aggregated group. Specifically, each relay node in the aggregated group may have a unique local relay node ID (assigned by the network node 101) associated with the aggregated group ID. The network node 101 may identify and control (or schedule) the devices in the aggregated group based on the aggregated group ID and the unique local relay node ID of each relay node 103. In addition, in the example, the relay node 103 may have a local relay node ID for the aggregated group and a pre-cell relay node ID.

In accordance with a novel aspect, when the network node 101 receives the relay node information with the capability information of the at least one relay node 103 in the aggregated group, the network node 101 may distinguish the at least one relay node 103 in the aggregated group based on the capability information of the at least one relay node 103 without assigning the relay node ID to the at least one relay node 103. That is to say, the network node 101 may directly transmit the scheduling to the UE 101 based on the capability information of the at least one relay node 103 in the aggregated group.

In accordance with a novel aspect, the scheduling scheduled by the network node 101 may indicates which device or devices in the aggregated group will be used to perform the data transmission or the data reception of the aggregation group. In an example, the network node 101 may directly transmit the scheduling to the UE 102. In another example, the network node 101 may also transmit the scheduling to the UE 102 through the relay node 103. Taking FIG. 2A as an example, the network node 201 may directly transmit the scheduling to the UE 202 or transmit the scheduling to the UE 202 through the relay node 203. In addition, in the scheduling, the network node 201 may indicate that only the UE 202 is used to perform the data transmission or the data reception of the aggregation group or the UE 202 and the network node 203 are used to perform the data transmission or the data reception of the aggregation group.

FIG. 3 is a simplified block diagram of a network node and a user equipment (UE) that carry out certain embodiments of the present invention. The network node 301 may be a base station (BS) or a gNB, but the present invention should not be limited thereto. The UE 302 may be a smart phone, a wearable device, an Internet of Things (IoT) device, and a tablet, etc. Alternatively, UE 302 may be a Notebook (NB) or Personal Computer (PC) inserted or installed with a data card which includes a modem and RF transceiver(s) to provide the functionality of wireless communication.

Network node 301 has an antenna array 311 having multiple antenna elements that transmits and receives radio signals, one or more RF transceiver modules 312, coupled with the antenna array 311, receives RF signals from antenna array 311, converts them to baseband signal, and sends them to processor 313. RF transceiver 312 also converts received baseband signals from processor 313, converts them to RF signals, and sends out to antenna array 311. Processor 313 processes the received baseband signals and invokes different functional modules 320 to perform features in network node 301. Memory 314 stores program instructions and data 315 to control the operations of network node 301. Network node 301 also includes multiple function modules that carry out different tasks in accordance with embodiments of the current invention.

Similarly, UE 302 has an antenna array 331, which transmits and receives radio signals. A RF transceiver 332, coupled with the antenna, receives RF signals from antenna array 331, converts them to baseband signals and sends them to processor 333. RF transceiver 332 also converts received baseband signals from processor 333, converts them to RF signals, and sends out to antenna array 331. Processor 333 processes the received baseband signals and invokes different functional modules 340 to perform features in UE 302. Memory 334 stores program instructions and data 335 to control the operations of UE 302. UE 302 also includes multiple function modules and circuits that carry out different tasks in accordance with embodiments of the current invention.

The functional modules and circuits 320 and 340 can be implemented and configured by hardware, firmware, software, and any combination thereof. The function modules and circuits 320 and 340, when executed by the processors 313 and 333 (e.g., via executing program codes 315 and 335), allow network node 301 and UE 302 to perform embodiments of the present invention.

In the example of FIG. 3, the network node 301 may comprise a configuration circuit 321 and a scheduling circuit 322. Configuration circuit 321 may generate the configuration based on the relay node information from the UE 302 to configure the relay node ID for the relay node in the aggregated group. Scheduling circuit 322 may schedule the operations of the devices of the aggregated group based on the configuration.

In the example of FIG. 3, the UE 302 may comprise a detecting circuit 341 and an assigning circuit 342. Detecting circuit 341 may detect the relay node. Assigning circuit 342 may assign the relay node ID configured by the network node 301 to the relay node in the aggregated group.

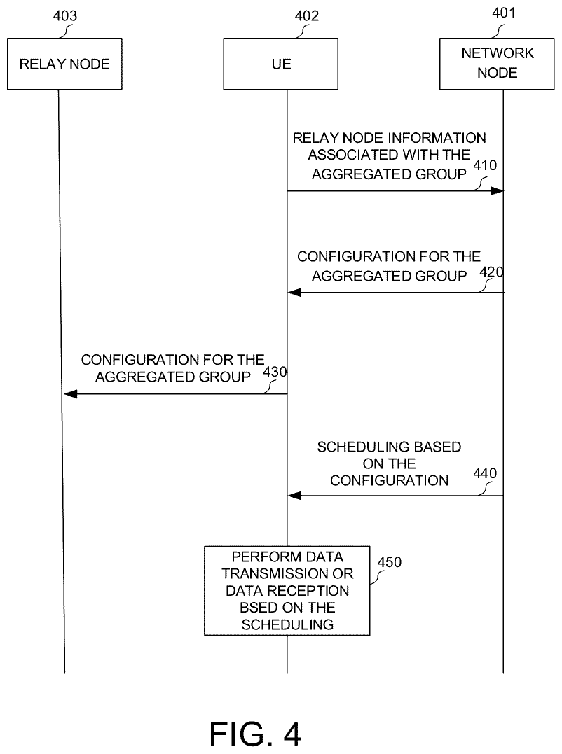

FIG. 4 illustrates a synergetic communication procedure in accordance with one novel aspect. In step 410, when the UE 402 detects the relay node 403, the UE 402 may transmit the relay node information associated with the aggregated group to the network node 401. In FIG. 4, the aggregated group may comprise the UE 402 and the relay node 403. The relay node information may comprise the capabilities of the UE 402 and the relay node 403.

In step 420, the network node 401 may configure the configuration for the aggregated group based on the relay node information. The configuration may comprise a relay node ID of the relay node 403. In addition, the configuration may further comprise an aggregated group ID of the aggregated group.

In step 430, the UE 402 may transmit the configuration to the relay node 403.

In step 440, the network node 401 may transmit a scheduling to the UE 402 based on the configuration. The scheduling may be used to control the operations for the aggregated group.

In step 450, the UE 402 may perform the data transmission or data reception based on the scheduling from the network node 401.

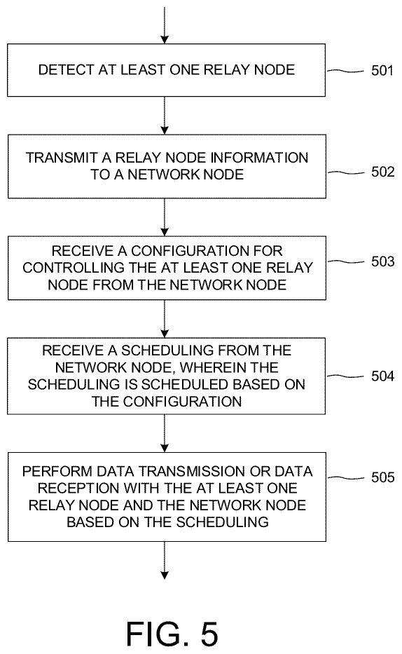

FIG. 5 is a flow chart of a synergetic communication method for relay node identification (ID) acquisition in accordance with one novel aspect. In step 501, a user equipment (UE) detects at least one relay node.

In step 502, the UE transmits a relay node information to a network node, wherein the replay node information comprises information of the at least one relay node. In an example, the relay node information may comprise a capability information of an aggregated group formed by the at least one relay node or a capability information of an aggregated group formed by the UE and the at least one relay node.

In step 503, the UE receives a configuration for controlling the at least one relay node from the network node. The configuration may comprise a relay node identification (ID) of the at least one relay node.

In step 504, the UE receives a scheduling from the network node, wherein the scheduling is scheduled based on the configuration.

In step 505, the UE performs data transmission or data reception with the at least one relay node and the network node based on the scheduling.

Although the present invention has been described in connection with certain specific embodiments for instructional purposes, the present invention is not limited thereto.

Accordingly, various modifications, adaptations, and combinations of various features of the described embodiments can be practiced without departing from the scope of the invention as set forth in the claims.

What is claimed is:

1. A method, comprising:
detecting, by a user equipment (UE), at least one relay node;
transmitting, by a user equipment (UE), a relay node information to a network node, wherein the relay node information comprises information of the at least one relay node;
receiving, by the UE, a configuration for controlling the at least one relay node from the network node;
receiving, by the UE, a scheduling from the network node, wherein the scheduling is scheduled based on the configuration; and
performing, by the UE, data transmission or data reception with the at least one relay node and the network node based on the scheduling.

2. The method of claim 1, further comprising:
transmitting, by the UE, the configuration to the at least one relay node;
wherein the configuration comprises a relay node identification (ID) of the at least one relay node.

3. The method of claim 2, wherein the relay node ID is unique in a cell or in an area.

4. The method of claim 2, wherein the relay node ID is associated with the UE.

5. The method of claim 1, wherein the relay node comprises a semi-static relay node identification (ID).

6. The method of claim 5, further comprising:
receiving, by the UE, the semi-static relay node ID from the at least one relay node; and
transmitting, by the UE, the relay node information with the semi-static relay node ID to the network node.

7. The method of claim 1, wherein the relay node information comprises a capability information of an aggregated group formed by the at least one relay node or a capability information of an aggregated group formed by the UE and the at least one relay node.

8. The method of claim 7, wherein the configuration for controlling the at least one relay node is configured based on the capability information.

9. The method of claim 7, wherein the relay node comprises a unique local identification (ID) within the aggregated group.

10. The method of claim 9, wherein the unique local ID is assigned by the network node, the UE or a master relay node.

11. A user equipment (UE), comprising:
a transmitter, transmitting a relay node information to a network node, wherein the relay node information comprises information of at least one relay node;
a receiver, receiving a configuration for controlling the at least one relay node from the network node and receiving a scheduling from the network node, wherein the scheduling is scheduled based on the configuration; and
a processor, detecting the at least one node and performing data transmission or data reception with the at least one relay node and the network node based on the scheduling.

12. The UE of claim 11, wherein the transmitter further transmits the configuration to the at least one relay node, wherein the configuration comprises a relay node identification (ID) of the at least one relay node.

13. The UE of claim 12, wherein the relay node ID is unique in a cell or in an area.

14. The UE of claim 12, wherein the relay node ID is associated with the UE.

15. The UE of claim 11, wherein the relay node comprises a semi-static relay node identification (ID).

16. The UE of claim 15, wherein the receiver further receives the semi-static relay node ID from the at least one relay node, and the transmitter further transmits the relay node information with the semi-static relay node ID to the network node.

17. The UE of claim 11, wherein the relay node information comprises a capability information of an aggregated group formed by the at least one relay node or a capability information of an aggregated group formed by the UE and the at least one relay node.

18. The UE of claim 17, wherein the configuration for controlling the at least one relay node is configured based on the capability information.

19. The UE of claim 17, wherein the relay node comprises a unique local identification (ID) within the aggregated group.

20. The UE of claim 19, wherein the unique local ID is assigned by the network node, the UE or a master relay node.
